(19) United States
(12) Patent Application Publication
(10) Pub. No.: US 2015/0156545 A1
(43) Pub. Date: Jun. 4, 2015

(54) METHOD AND SYSTEM FOR PROVIDING MEDIA RECOMMENDATIONS

(71) Applicant: THOMSON LICENSING, Issy les Moulineaux (FR)

(72) Inventors: Branislav Kveton, San Jose, CA (US); Jonathan Whiteaker, Menlo Park, CA (US); Jean Bolot, Los Altos, CA (US); Ashwin Kashyap, Mountai View, CA (US); Sandilya Bhamidipati, Palo Alto, CA (US)

(21) Appl. No.: 14/370,214

(22) PCT Filed: Dec. 13, 2012
(86) PCT No.: PCT/US2012/072314

§ 371 Date: Jan. 22, 2015

Related U.S. Application Data
(60) Provisional application No. 61/583,007, filed on Jan. 4, 2012.
(60) Provisional application No. 61/673,815, filed on Jul. 20, 2012.
(60) Provisional application No. 61/673,822, filed on Jul. 20, 2012.

(51) Int. Cl. H04N 21/442; H04N 21/466; H04N 21/45; H04N 21/25

(52) U.S. Cl. CPC H04N 21/44222; H04N 21/251; H04N 21/4668; H04N 21/44218; H04N 21/4532

(57) ABSTRACT

A system and method and graphic user interface for providing media recommendations. The system and method including enabling a user to select a first media object or a second media object from a plurality of accessible media objects, the first media object having a first set of characteristics and the second media object having a second set of characteristics, determining if a user selects the first media object, selects the second media object, or requests access to two different media objects, adjusting weight values associated with the plurality of media objects based on the user's selection, and recommending media objects to the user based on the adjusted weight values.

### REFERENCE TO RELATED PROVISIONAL APPLICATION

This application claims priority from U.S. provisional application No. 61/583,007, entitled “METHOD AND SYSTEM FOR PROVIDING MEDIA RECOMMENDATIONS” filed on Jan. 4, 2012 and from U.S. provisional application No. 61/673,815, entitled “METHOD AND SYSTEM FOR PROVIDING MEDIA RECOMMENDATIONS” filed on Jul. 20, 2012 and from U.S. provisional application No. 61/673,822, entitled “METHOD AND SYSTEM FOR PROVIDING MEDIA RECOMMENDATIONS” filed on Jul. 20, 2012, all of which are incorporated by reference herein in their entirety.

### TECHNICAL FIELD OF THE INVENTION

The present disclosure generally relates to digital content systems and methods for searching through a large amount of media content efficiently and in a graphical way, and more particularly, to a system, method and graphic user interface for providing media recommendations.

### BACKGROUND OF THE INVENTION

Home entertainment systems, including television and media centers, are converging with the Internet and providing access to a large number of available sources of content, such as video, movies, TV programs, music, etc. This expansion in the number of available sources necessitates a new strategy for navigating a media interface associated with such systems and making content recommendations and selections.

The large number of possible content sources creates an interface challenge that has not yet been successfully solved in the field of home media entertainment. This challenge involves successfully presenting users with a large number of elements (programs, sources, etc.) without the need to tediously navigate through multiple display pages or hierarchies of content.

Further, most existing search paradigms make an assumption that the user knows what they are looking for when they start, whereas often, a mechanism to allow a process of discovery and cross linkage is more desirable or appropriate.

One approach for allowing a process of discovery and cross linkage is the tracking a user's viewing/purchasing habits over a period of time. However, tracking user's viewing/purchasing habits over a long time period to generate relevant recommendations also has the drawback of being time consuming.

The present disclosure is directed towards overcoming these drawbacks.

### SUMMARY

A system and method and graphic user interface for providing media recommendations. The system and method including enabling a user to select a first media object or a second media object from a plurality of accessible media objects, the first media object having a first set of characteristics and the second media object having a second set of characteristics, determining if a user selects the first media object, selects the second media object, or requests access to two different media objects, adjusting weight values associated with the plurality of media objects based on the user's selection, and recommending media objects to the user based on the adjusted weight values.

### BRIEF DESCRIPTION OF THE DRAWINGS

These, and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 is a block diagram of an exemplary system for delivering content in accordance with the present disclosure;

FIG. 2 is a block diagram of an exemplary set-top box/digital video recorder (DVR) in accordance with the present disclosure;

FIG. 3 is a perspective view of an exemplary remote controller, tablet and/or second screen device in accordance with an embodiment of the present disclosure;

FIG. 4 illustrates a number of gestures in accordance with an embodiment of the present disclosure;

FIG. 5 illustrates an exemplary embodiment of a user interface of the present disclosure;

FIG. 6 illustrates an exemplary embodiment of a user interface of the present disclosure;

FIG. 7 illustrates an exemplary embodiment of a user interface of the present disclosure;

FIG. 8 illustrates an exemplary embodiment of a user interface of the present disclosure;

FIG. 9 illustrates an exemplary embodiment of a user interface of the present disclosure;

FIG. 10 illustrates an exemplary embodiment of a user interface of the present disclosure;

FIG. 11 illustrates an exemplary embodiment of a user interface of the present disclosure;

FIG. 12 illustrates an exemplary embodiment of a user interface of the present disclosure;

FIG. 13 illustrates an exemplary embodiment of a user interface of the present disclosure;

FIG. 14 illustrates an exemplary embodiment of a user interface of the present disclosure; and

FIG. 15 illustrates an exemplary flowchart of the present disclosure.

It should be understood that the drawing(s) is for purposes of illustrating the concepts of the disclosure and is not necessarily the only possible configuration for illustrating the disclosure.

### DETAILED DESCRIPTION OF PREFERRED EMBODIMENTS

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for instructional purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

The proposed disclosure is directed towards a method and system for enabling a user to obtain dynamic and adjustable recommendations based on a personal preference toward one particular piece of media by moving to a smart shelf. The system and method of the present disclosure allows for an immediate response giving an alternative to capturing data over time and learning user patterns.

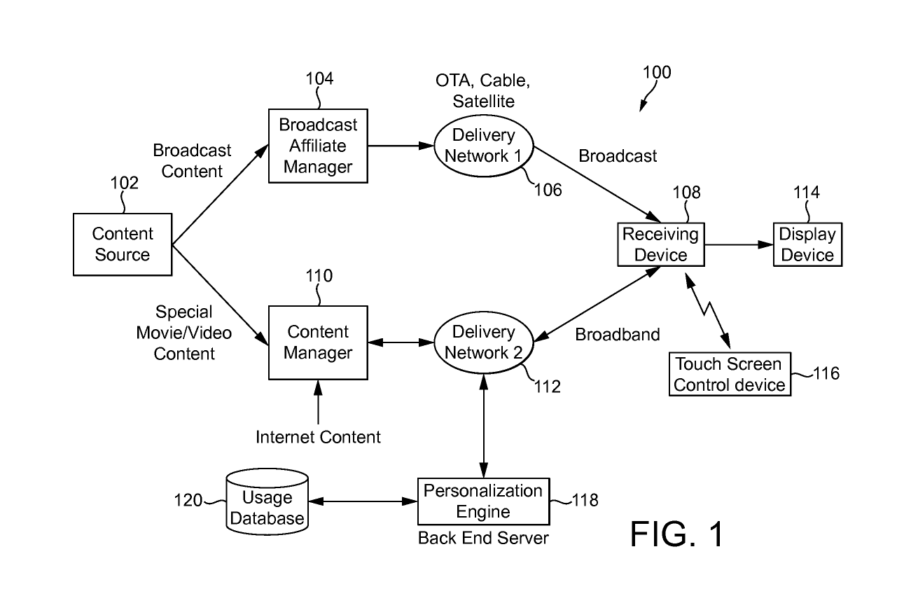

Turning now to FIG. 1, a block diagram of an embodiment of a system 100 for delivering content to a home or end user is shown. The content originates from a content source 102, such as a movie studio or production house. The content may be supplied in at least one of two forms. One form may be a broadcast form of content. The broadcast content is provided to the broadcast affiliate manager 104, which is typically a national broadcast service, such as the American Broadcasting Company (ABC), National Broadcasting Company (NBC), Columbia Broadcasting System (CBS), etc. The broadcast affiliate manager may collect and store the content, and may schedule delivery of the content over a deliver network, shown as delivery network 1 (106). Delivery network 1 (106) may include satellite link transmission from a national center to one or more regional or local centers. Delivery network 1 (106) may also include local content delivery using local delivery systems such as over the air broadcast, satellite broadcast, or cable broadcast. The locally delivered content is provided to a receiving device 108 in a user's home, where the content will subsequently be searched by the user. It is to be appreciated that the receiving device 108 can take many forms and may be embodied as a set top box/digital video recorder (DVR), a gateway, a modem, etc. Further, the receiving device 108 may act as entry point, or gateway, for a home network system that includes additional devices configured as either client or peer devices in the home network.

A second form of content is referred to as special content. Special content may include content delivered as premium viewing, pay-per-view, or other content otherwise not provided to the broadcast affiliate manager, e.g., movies, video games or other video elements. In many cases, the special content may be content requested by the user. The special content may be delivered to a content manager 110. The content manager 110 may be a service provider, such as an Internet website, affiliated, for instance, with a content provider, broadcast service, or delivery network service. The content manager 110 may also incorporate Internet content into the delivery system. The content manager 110 may deliver the content to the user's receiving device 108 over a separate delivery network, delivery network 2 (112). Delivery network 2 (112) may include high-speed broadband Internet type communications systems. It is important to note that the content from the broadcast affiliate manager 104 may also be delivered using all or parts of delivery network 2 (112) and content from the content manager 110 may be delivered using all or parts of delivery network 1 (106). In addition, the user may also obtain content directly from the Internet via delivery network 2 (112) without necessarily having the content managed by the content manager 110.

Several adaptations for utilizing the separately delivered content may be possible. In one possible approach, the special content is provided as an augmentation to the broadcast content, providing alternative displays, purchase and merchandising options, enhancement material, etc. In another embodiment, the special content may completely replace some programming content provided as broadcast content. Finally, the special content may be completely separate from the broadcast content, and may simply be a media alternative that the user may choose to utilize. For instance, the special content may be a library of movies that are not yet available as broadcast content.

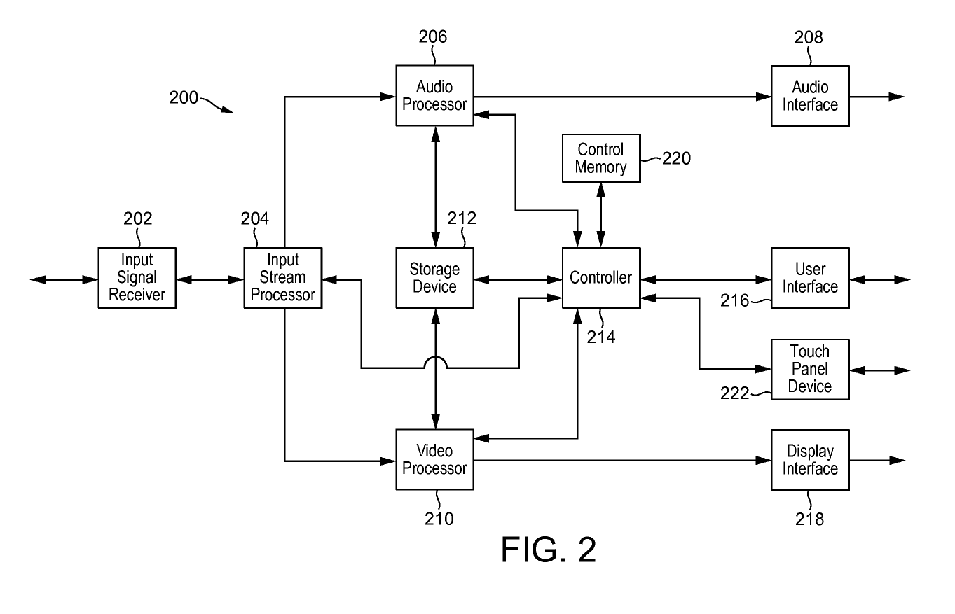

The receiving device 108 may receive different types of content from one or both of delivery network 1 and delivery network 2. The receiving device 108 processes the content, and provides a separation of the content based on user preferences and commands. The receiving device 108 may also include a storage device, such as a hard drive or optical disk drive, for recording and playing back audio and video content. Further details of the operation of the receiving device 108 and features associated with playing back stored content will be described below in relation to FIG. 2. The processed content is provided to a display device 114. The display device 114 may be a conventional 2-D type display or may alternatively be an advanced 3-D display.

The receiving device 108 may also be interfaced to a second screen such as a touch screen control device 116. The touch screen control device 116 may be adapted to provide user control for the receiving device 108 and/or the display device 114. The touch screen device 116 may also be capable of displaying video content. The video content may be graphics entries, such as user interface entries (as discussed below), or may be a portion of the video content that is delivered to the display device 114. The touch screen control device 116 may interface to receiving device 108 using any well-known signal transmission system, such as infra-red (IR) or radio frequency (RF) communications and may include standard protocols such as infra-red data association (IRDA) standard, Wi-Fi, Bluetooth and the like, or any other proprietary protocols. Operations of touch screen control device 116 will be described in further detail below.

Optionally, media device 108 and touch screen control device 116 may be integrated into the same device. Examples of media devices with a touch screen include, but are not limited to, computers, laptops, wireless phones, cell phones, personal media players, MP3 players, personal digital assistants (PDAs), tablet devices, digital video recorders, gateways, and the like. For purposes of the specification, the term media device can encompass all of these types of devices.

In the example of FIG. 1, the system 100 also includes a back end server 118 and a usage database 120. As discussed in further detail below, the back end server 118 includes a personalization engine that analyzes the selections (e.g., media asset selections) of a user and makes recommendations based on those selections. The usage database 120 may be where the selections for a user are stored (alternatively the selections or selection habits may be stored elsewhere in system 100 such as receiving device 108, control device 116, 300 and/or display device 114). In some cases, the usage database 120 may be part of the back end server 118. In the present example, the back end server 118 (as well as the usage database 120) is connected to the system 100 and accessed through the delivery network 2 (112).

Turning now to FIG. 2, a block diagram of an embodiment of a receiving device 200 is shown. Receiving device 200 may operate similar to the receiving device described in FIG. 1 and may be included as part of a gateway device, modem, set-top box, or other similar communications device. The device 200 shown may also be incorporated into other systems including an audio device or a display device. In either case, several components necessary for complete operation of the system are not shown in the interest of conciseness, as they are well known to those skilled in the art.

In the device 200 shown in FIG. 2, the content is received by an input signal receiver 202. The input signal receiver 202 may be one of several known receiver circuits used for receiving, demodulation, and decoding signals provided over one of the several possible networks including over the air, cable, satellite, Ethernet, fiber and phone line networks. The desired input signal may be selected and retrieved by the input signal receiver 202 based on user input provided through a control interface or touch panel interface 222. Touch panel interface 222 may include an interface for a touch screen device. Touch panel interface 222 may also be adapted to interface to a cellular phone, a tablet, a mouse, a high end remote or the like.

The decoded output signal is provided to an input stream processor 204. The input stream processor 204 performs the final signal selection and processing, and includes separation of video content from audio content for the content stream. The audio content is provided to an audio processor 206 for conversion from the received format, such as compressed digital signal, to an analog waveform signal. The analog waveform signal is provided to an audio interface 208 and further to the display device or audio amplifier. Alternatively, the audio interface 208 may provide a digital signal to an audio output device or display device using a High-Definition Multimedia Interface (HDMI) cable or alternate audio interface such as via a Sony/Philips Digital Interconnect Format (SPDIF). The audio interface may also include amplifiers for driving one more sets of speakers. The audio processor 206 also performs any necessary conversion for the storage of the audio signals.

The video output from the input stream processor 204 is provided to a video processor 210. The video signal may be one of several formats. The video processor 210 provides, as necessary a conversion of the video content, based on the input signal format. The video processor 210 also performs any necessary conversion for the storage of the video signals.

A storage device 212 stores audio and video content received at the input. The storage device 212 allows later retrieval and playback of the content under the control of a controller 214 and also based on commands, e.g., navigation instructions such as fast-forward (FF) and rewind (Rew), received from a user interface 216 and/or touch panel interface 222. The storage device 212 may be a hard disk drive, one or more large capacity integrated electronic memories, such as static RAM (SRAM), or dynamic RAM (DRAM), or may be an interchangeable optical disk storage system such as a compact disk (CD) drive or digital video disk (DVD) drive.

The converted video signal, from the video processor 210, either originating from the input or from the storage device 212, is provided to the display interface 218. The display interface 218 further provides the display signal to a display device of the type described above. The display interface 218 may be an analog signal interface such as red-green-blue (RGB) or may be a digital interface such as HDMI. It is to be appreciated that the display interface 218 will generate the various screens for presenting the search results (e.g., in a three dimensional gird, two dimensional array, a shelf, or the like).

The controller 214 is interconnected via a bus to several of the components of the device 200, including the input stream processor 204, audio processor 206, video processor 210, storage device 212, and a user interface 216. The controller 214 manages the conversion process for converting the input stream signal into a signal for storage on the storage device or for display. The controller 214 also manages the retrieval and playback of stored content. Furthermore, as will be described below, the controller 214 performs searching of content and the creation and adjusting of the grid, array and/or shelf display representing the content, either stored or to be delivered via the delivery networks, described above.

The controller 214 is further coupled to control memory 220 (e.g., volatile or non-volatile memory, including RAM, SRAM, DRAM, ROM, programmable ROM (PROM), flash memory, electronically programmable ROM (EPROM), electronically erasable programmable ROM (EEPROM), etc.) for storing information and instruction code for controller 214. Control memory 220 may store instructions for controller 214. Control memory may also store a database of elements, such as graphic elements containing content. The database may be stored as a pattern of graphic elements, such as graphic elements containing content, various graphic elements used for generating a displayable user interface for display interface 218, and the like. Alternatively, the memory may store the graphic elements in identified or grouped memory locations and use an access or location table to identify the memory locations for the various portions of information related to the graphic elements. Additional details related to the storage of the graphic elements will be described below. Further, the implementation of the control memory 220 may include several possible embodiments, such as a single memory device or, alternatively, more than one memory circuit communicatively connected or coupled together to form a shared or common memory. Still further, the memory may be included with other circuitry, such as portions of bus communications circuitry, in a larger circuit.

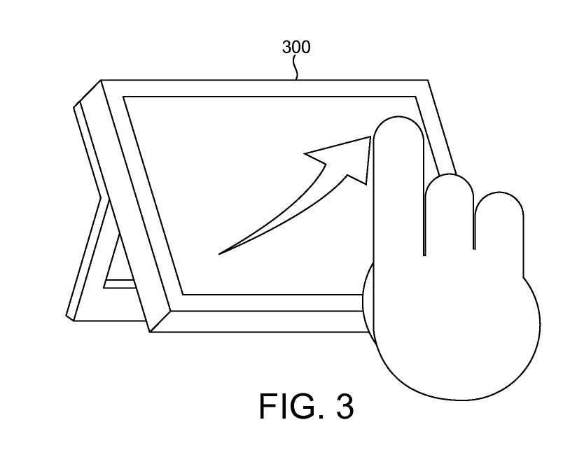

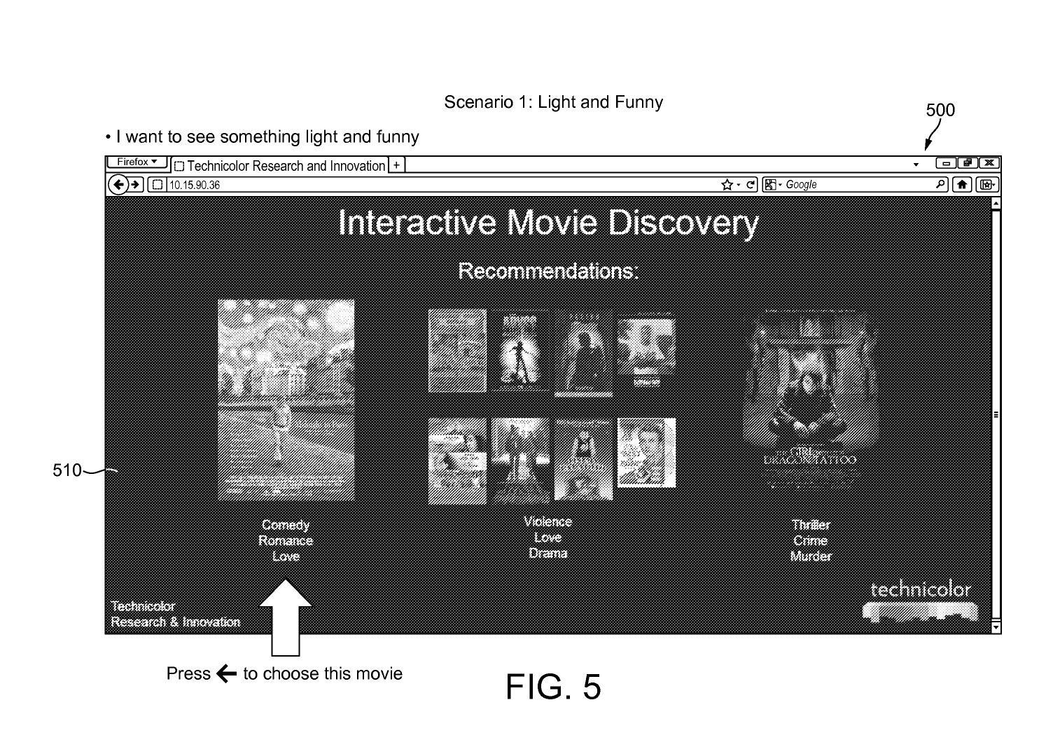

Turning now to FIG. 3, the user interface process of the present disclosure employs an input device that can be used to express functions, such as fast forward, rewind, etc. To allow for this, a tablet or touch panel device 300 (which is the same as the touch screen device 116 shown in FIG. 1 and/or is an integrated example of media device 108 and touch screen device 116) may be interfaced via the user interface 216 and/or touch panel interface 222 of the receiving device 200. The touch panel device 300 allows operation of the receiving device or set top box based on hand movements, or gestures, and actions translated through the panel into commands for the set top box or other control device. In one embodiment, the touch panel 300 may simply serve as a navigational tool to navigate the grid display. In other embodiments, the touch panel 300 will additionally serve as the display device allowing the user to more directly interact with the navigation through the grid display of content. The touch panel device may be included as part of a remote control device containing more conventional control functions such as activator and/or actuator buttons. The touch panel 300 can also include at least one camera element. As described below, the touch panel device 300 (or display device 114) may utilize a media asset discovery function (see e.g., FIGS. 5-15) to provide media recommendations to a user.

Optionally, controller 214 can be adapted to extract metadata, criteria, characteristics or the like from audio and video media by using audio processor 206 and video processor 210, respectively. That is, metadata, criteria, characteristics or the like that is contained in video signal in the vertical blanking interval, auxiliary data fields associated with video, or in other areas in the video signal can be harvested by using the video processor 210 with controller 214 as to generate metadata that can be used for functions such as generating an electronic program guide, have descriptive information about received video, supporting an auxiliary information service, and the like. Similarly, the audio processor 206 working with controller 214 can be adapted to recognize audio watermarks that may be in an audio signal. Such audio watermarks can then be used to perform some action such as the recognition of the audio signal, security which identifies the source of an audio signal, or perform some other service. Furthermore, metadata, criteria, characteristics or the like, to support the actions listed above can come from a network source which are processed by controller 214.

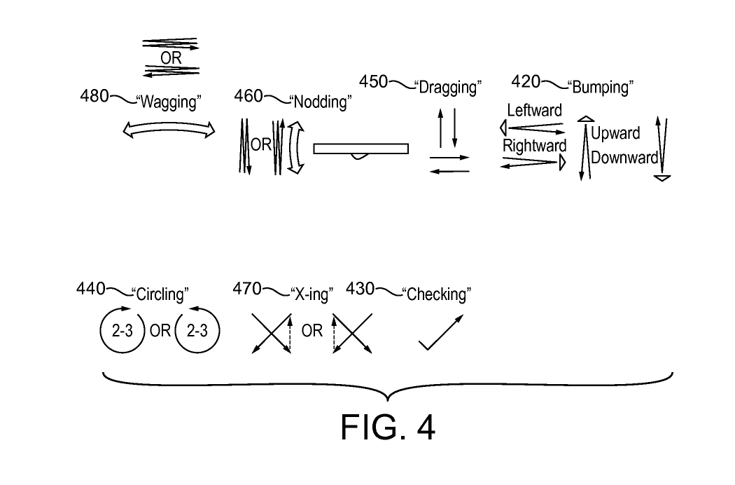

Turning now to FIG. 4, the use of a gesture sensing controller or touch screen, such as shown, provides for a number of types of user interaction. The inputs from the controller are used to define gestures and the gestures, in turn, define specific contextual commands. The configuration of the sensors (e.g., touch screen sensor and/or inertial sensors such as accelerometer and gyroscope sensors) may permit defining movement of a user's fingers on a touch screen or may even permit defining the movement of the controller itself in either one dimension or two dimensions. Two-dimensional motion, such as a diagonal, and a combination of yaw, pitch and roll can be used to define any three-dimensional motion, such as a swing. A number of gestures are illustrated in FIG. 4. Gestures are interpreted in context and are identified by defined movements made by the user.

Bumping 420 is defined by a two-stroke drawing indicating pointing in one direction, either up, down, left or right. The bumping gesture is associated with specific commands in context. For example, in a TimeShifting mode, a left-bump gesture 420 indicates rewinding, and a right-bump gesture indicates fast-forwarding. In other contexts, a bump gesture 420 is interpreted to increment a particular value in the direction designated by the bump. Checking 440 is defined as in drawing a checkmark. It is similar to a downward bump gesture 420. Checking is identified in context to designate a reminder, user tag or to select an item or element. Circling 440 is defined as drawing a circle in either direction. It is possible that both directions could be distinguished. However, to avoid confusion, a circle is identified as a single command regardless of direction. Dragging 450 is defined as an angular movement of the controller (a change in pitch and/or yaw) while pressing a button (virtual or physical) on the tablet 300 (i.e., a “trigger drag”). The dragging gesture 450 may be used for navigation, speed, distance, time-shifting, rewinding, and forwarding. Dragging 450 can be used to move a cursor, a virtual cursor, or a change of state, such as highlighting outlining or selecting on the display. Dragging 450 can be in any direction and is generally used to navigate in two dimensions. However, in certain interfaces, it is preferred to modify the response to the dragging command. For example, in some interfaces, operation in one dimension or direction is favored with respect to other dimensions or directions depending upon the position of the virtual cursor or the direction of movement. Nodding 460 is defined by two fast trigger-drag up-and-down vertical movements. Nodding 460 is used to indicate “Yes” or “Accept.” X-ing 470 is defined as in drawing the letter “X.” X-ing 470 is used for “Delete” or “Block” commands. Wagging 480 is defined by two trigger-drag fast back-and-forth horizontal movements. The wagging gesture 480 may be used to indicate “No” or “Cancel” or to move displayed or virtual objects (e.g. cursors) horizontally.

Depending on the complexity of the sensor system, only simple one dimensional motions or gestures may be allowed. For instance, a simple right or left movement on the sensor as shown here may produce a fast forward or rewind function. In addition, multiple sensors could be included and placed at different locations on the touch screen. For instance, a horizontal sensor for left and right movement may be placed in one spot and used for volume up/down, while a vertical sensor for up and down movement may be place in a different spot and used for channel up/down. In this way specific gesture mappings may be used. The user may interact with the smart shelf page, described below, using gestures performed on the tablet 300. Further description of a sensor system arrangement in accordance with the present disclosure is provided in further detail below.

Referring now to FIG. 5, an exemplary embodiment of a user interface 500 showing a collection of media assets, elements or thumbnails in accordance with the present disclosure is shown. Specifically, display area 510 shows a collection of media assets that are represented by different graphics/icons. The collection of media assets includes a leftmost media asset (“Midnight in Paris”), a rightmost media asset (“The Girl With The Dragon Tattoo”), and a number of recommended media assets. These media assets can be selected for playback by using a gesture/control interface command, whereby a media device (e.g., media device 108, display device 114 and/or touch panel device 300) will playback a selected media asset by retrieving such an asset from a storage medium, requesting the asset from a server, activating an attached playback device, and the like. Additionally, the leftmost media asset (“Midnight in Paris”) or the rightmost media asset (“The Girl With The Dragon Tattoo”) may be selected by the user via a gesture/control interface command such that new recommended media assets are shown. Metadata, characteristic or criteria for the leftmost, rightmost and recommended media assets are also displayed. For example, Comedy, Romance and Love categories are shown as relevant to the leftmost media asset (“Midnight in Paris”), Thriller, Crime and Murder categories are shown as relevant to the rightmost media asset (“The Girl With The Dragon Tattoo”), and Violence, Love and Drama categories are shown as relevant to the recommended media assets.

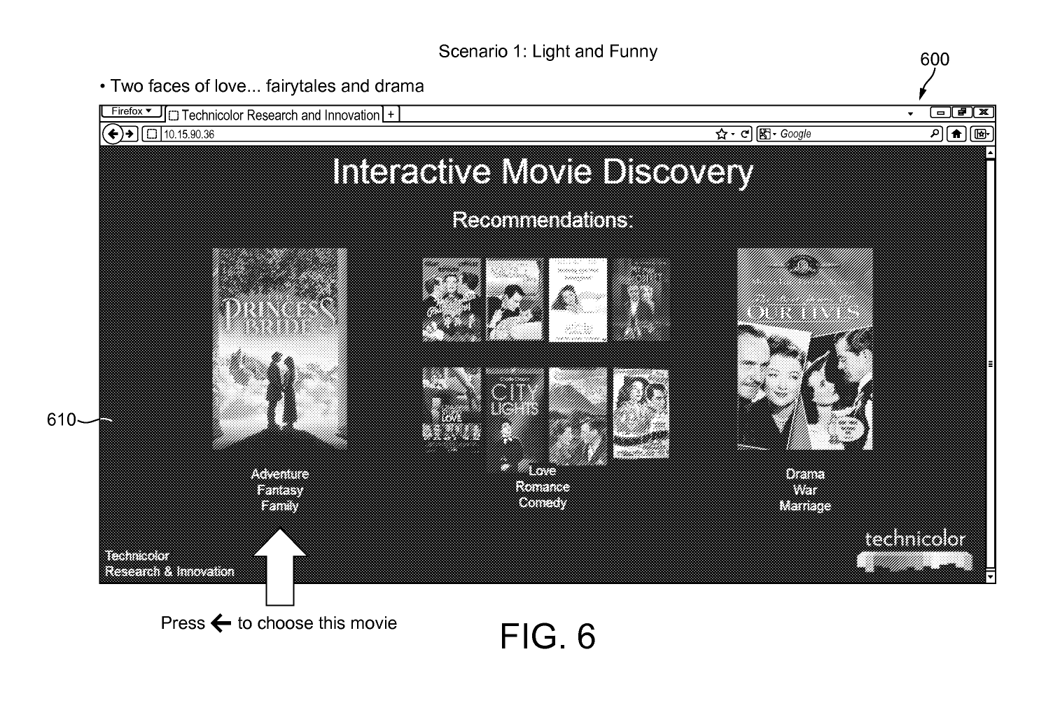

In a first recommendation scenario, the user may desire to view a comedy media asset rather than a crime or murder media asset and, in accordance with the present disclosure, the user may select the leftmost media asset (“Midnight in Paris”). Turning now to FIG. 6, the user may be presented with a user interface 600 having a display area 610 in which a new leftmost media asset (“The Princess Bride”), a new rightmost media asset (“The Best Years Of Our Lives”), and new recommended media assets are shown. In this example, the leftmost media asset (“The Princess Bride”) is associated with Adventure, Fantasy and Family categories, the rightmost media asset (“The Best Years Of Our Lives”) is associated with Drama, War and Marriage categories, and the recommended media assets are associated with Love, Romance and Comedy categories.

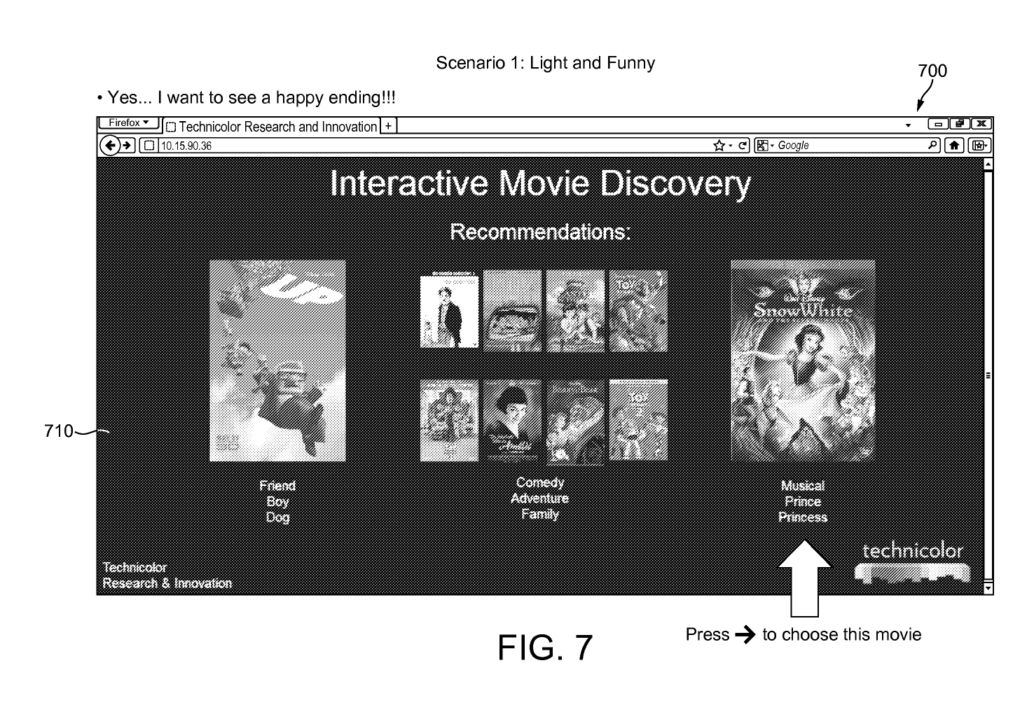

If the user desires to view a fairytale or fantasy type of media asset rather than a drama type of media asset, in accordance with the present disclosure, the user could select the leftmost media asset (“The Princess Bride”). Turning now to FIG. 7, the user may be presented with a user interface 700 having a display area 710 in which a new leftmost media asset (“UP”), a new rightmost media asset (“Snow White And The Seven Dwarfs”), and new recommended media assets are shown. In this example, the leftmost media asset (“UP”) is associated with Friend, Boy and Dog categories, the rightmost media asset (“Snow White And The Seven Dwarfs”) is associated with Musical, Price and Princess categories, and the recommended media assets are associated with Comedy, Adventure and Family categories.

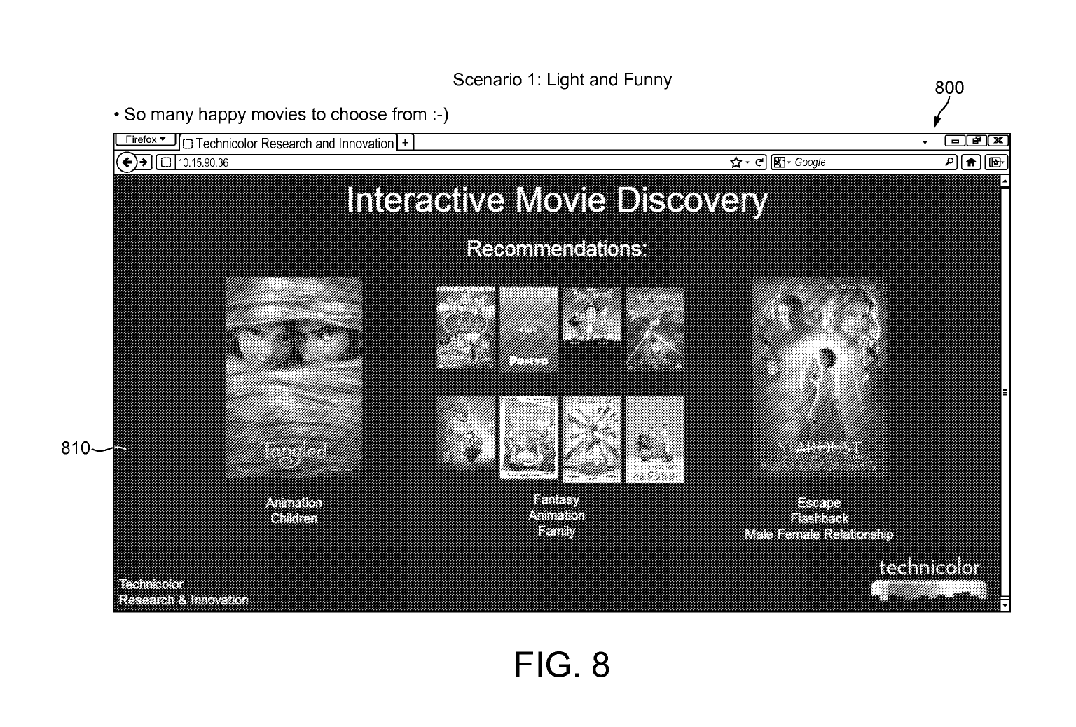

If the user desires to see a musical or princess type of media asset rather than a friend or dog type of media asset, the user could select the rightmost media asset (“Snow White And The Seven Dwarfs”). Turning now to FIG. 8, the user may be presented with a user interface 800 having a display area 810 in which a new leftmost media asset (“Tangled”), a new rightmost media asset (“Stardust”), and new recommended media assets are shown. In this example, the leftmost media asset (“Tangled”) is associated with Animation and Children categories, the rightmost media asset (“Stardust”) is associated with Escape, Flashback and Male Female Relationship categories, and the recommended media assets are associated with Fantasy, Animation and Family categories. At this point the user may observe a media asset that the user desires to view. As discussed above and in further detail below, the media asset can be selected for playback by using a gesture/control interface command, whereby a media device (e.g., media device 108, display device 114 and/or touch panel device 300) will playback a selected media asset by retrieving such an asset from a storage medium, requesting the asset from a server, activating an attached playback device, and the like. It should also be noted that the user at anytime may have selected a desired media asset as the user navigated through the user interfaces (500, 600, 700, 800) shown in FIGS. 5-8.

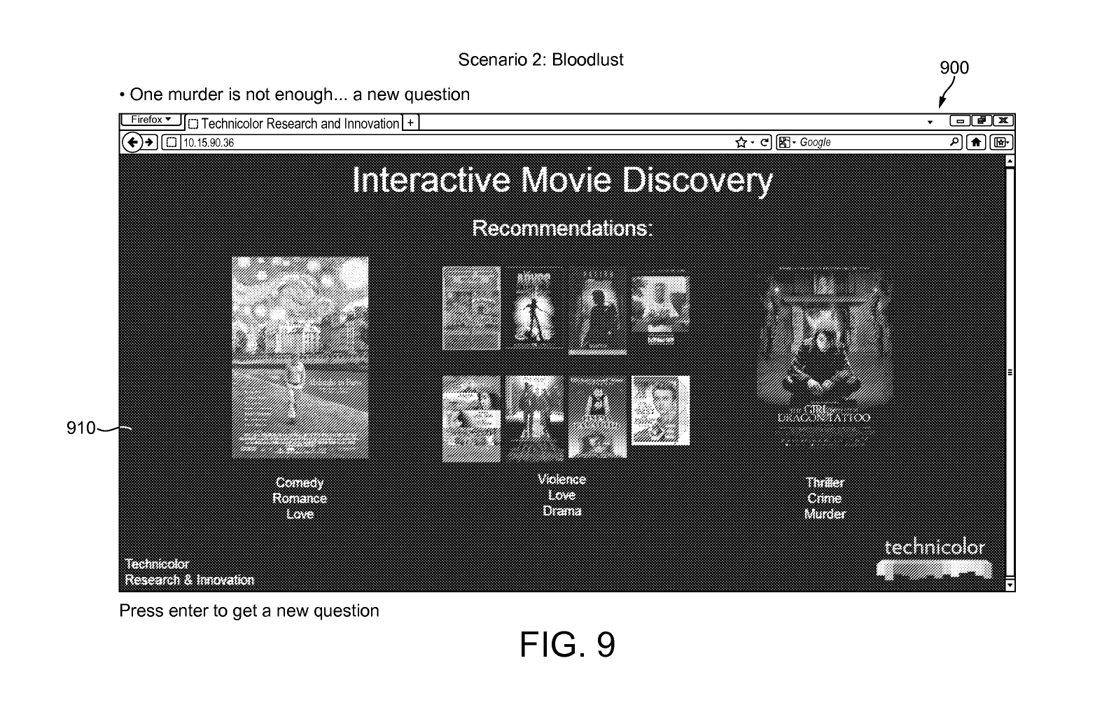

Turning now to FIGS. 9-14, an alternative recommendation scenario in accordance with the present disclosure is shown. In this alternative recommendation scenario the user may desire to view a murder type of media asset rather than a comedy type of media asset.

Referring now to FIG. 9, the user may be presented with a user interface 900 having a display area 910 displaying a collection of media assets including a leftmost media asset (“Midnight in Paris”), a rightmost media asset (“The Girl With The Dragon Tattoo”), and a number of recommended media assets. Comedy, Romance and Love categories are shown as relevant to the leftmost media asset (“Midnight in Paris”), Thriller, Crime and Murder categories are shown as relevant to the rightmost media asset (“The Girl With The Dragon Tattoo”), and Violence, Love and Drama categories are shown as relevant to the recommended media assets.

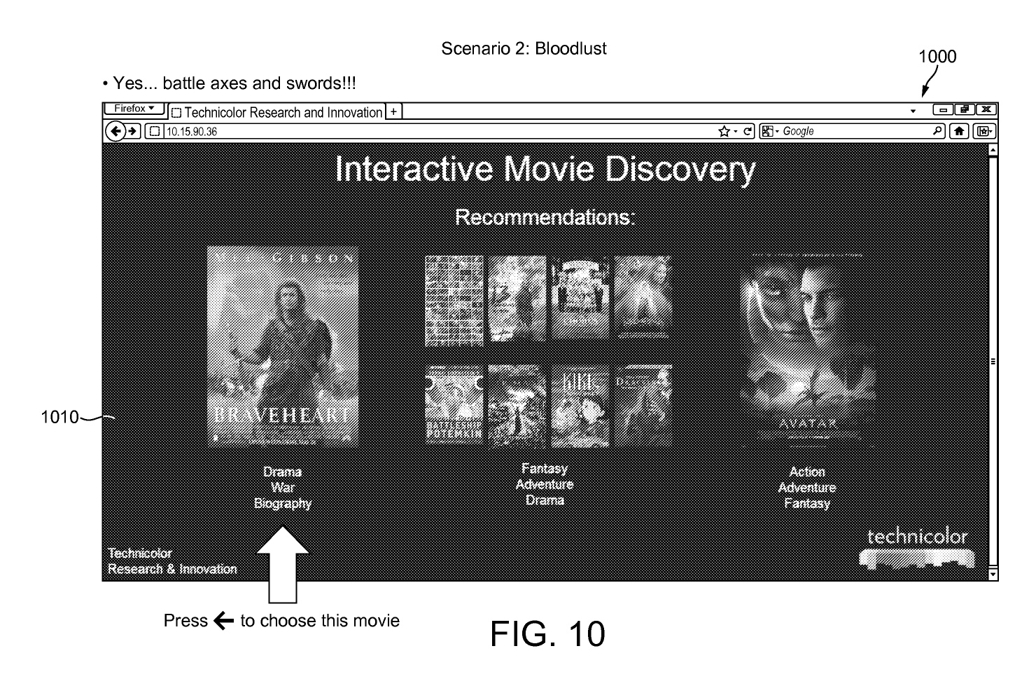

In the second recommendation scenario, the user may desire to view a murder media asset rather than a comedy media asset and, in accordance with the present disclosure, the user could select the rightmost media asset (“The Girl With The Dragon Tattoo”). Referring now to FIG. 10, the user may be presented with a user interface 1000 having a display area 1010 in which a new leftmost media asset (“Braveheart”), a new rightmost media asset (“Avatar”), and new recommended media assets are shown. In this example, the leftmost media asset (“Braveheart”) is associated with Drama, War and Biography categories, the rightmost media asset (“Avatar”) is associated with Action, Adventure and Fantasy categories, and the recommended media assets are associated with Fantasy, Adventure and Drama categories.

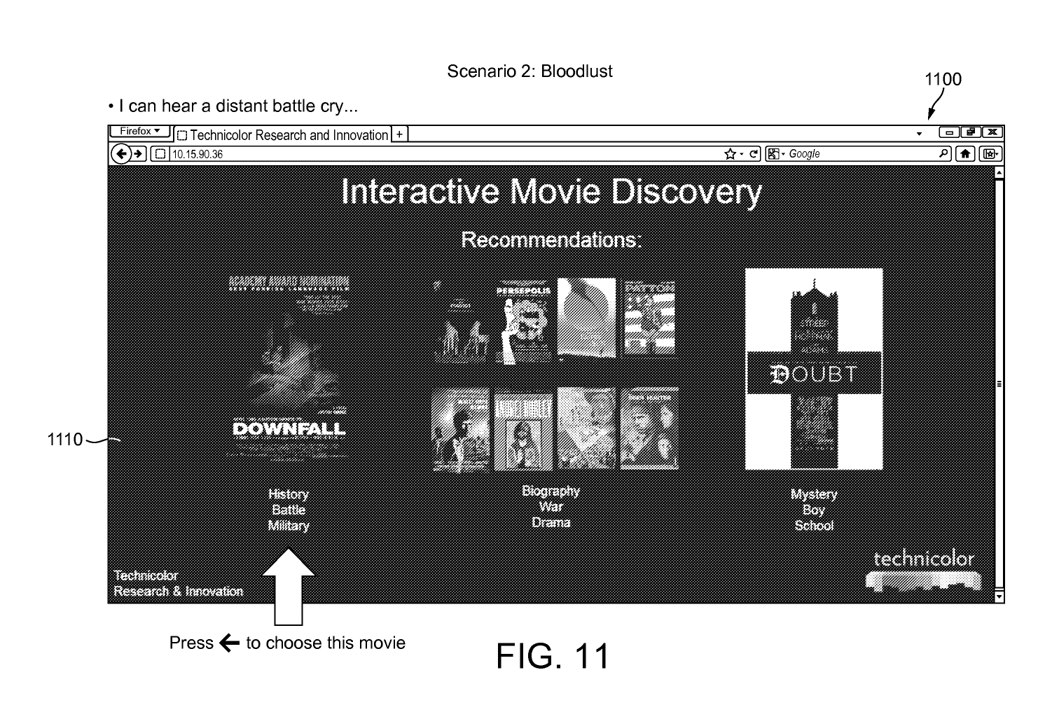

If the user desires to view a drama or war type of media asset rather than an action or adventure type of media asset, in accordance with the present disclosure, the user could select the leftmost media asset (“Braveheart”). Turning now to FIG. 11, the user may be presented with a user interface 1100 having a display area 1110 in which a new leftmost media asset (“Downfall”), a new rightmost media asset (“Doubt”), and new recommended media assets are shown. In this example, the leftmost media asset (“Downfall”) is associated with History, Battle and Military categories, the rightmost media asset (“Doubt”) is associated with Mystery, Boy and School categories, and the recommended media assets are associated with Biography, War and Drama categories.

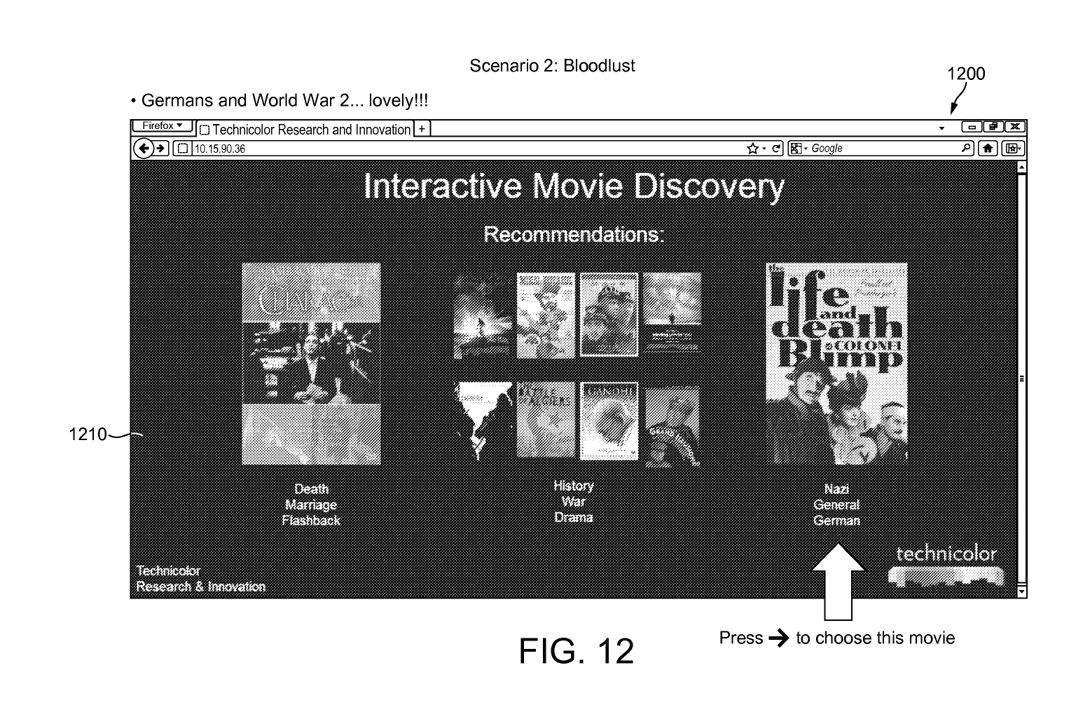

If the user desires to view a battle or military type of media asset rather than a mystery or school type of media asset, in accordance with the present disclosure, the user could select the leftmost media asset (“Downfall”). Turning now to FIG. 12, the user may be presented with a user interface 1200 having a display area 1210 in which a new leftmost media asset (“Character”), a new rightmost media asset (“The Life And Death Of Colonel Blimp”), and new recommended media assets are shown. In this example, the leftmost media asset (“Character”) is associated with Death, Marriage and Flashback categories, the rightmost media asset (“The Life And Death Of Colonel Blimp”) is associated with Nazi, General and German categories, and the recommended media assets are associated with History, War and Drama categories.

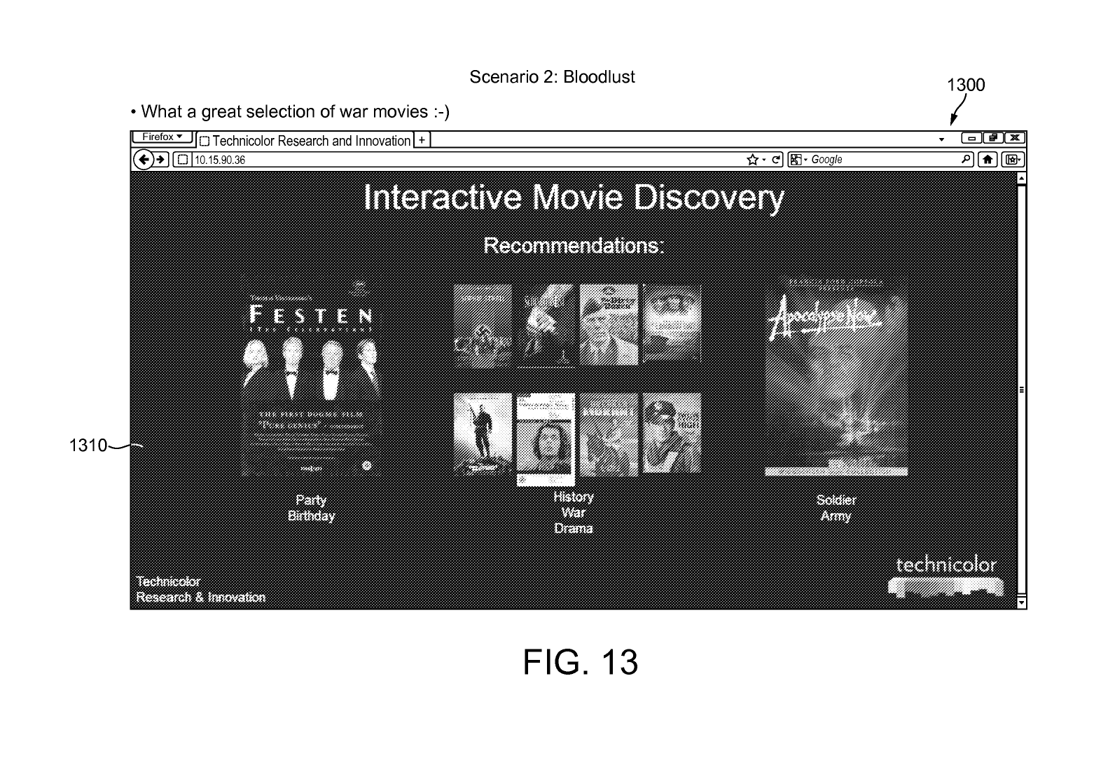

If the user desires to view a German or World War 2 type of media asset rather than a death or marriage type of media asset, in accordance with the present disclosure, the user could select the rightmost media asset (“The Life And Death Of Colonel Blimp”). Turning now to FIG. 13, the user may be presented with a user interface 1300 having a display area 1310 in which a new leftmost media asset (“Festen”), a new rightmost media asset (“Apocalypse Now”), and new recommended media assets are shown. In this example, the leftmost media asset (“Festen”) is associated with Party and Birthday categories, the rightmost media asset (“Apocalypse Now”) is associated with Soldier and Army categories, and the recommended media assets are associated with History, War and Drama categories. At this point the user may observe a media asset that the user desires to view. As discussed above and in further detail below, the media asset can be selected for playback by using a gesture/control interface command, whereby a media device (e.g., media device 108, display device 114 and/or touch panel device 300) will playback a selected media asset by retrieving such an asset from a storage medium, requesting the asset from a server, activating an attached playback device, and the like. It should also be noted that the user at anytime may have selected a desired media asset as the user navigated through the user interfaces (900, 1000, 1100, 1200, 1300) shown in FIGS. 9-13.

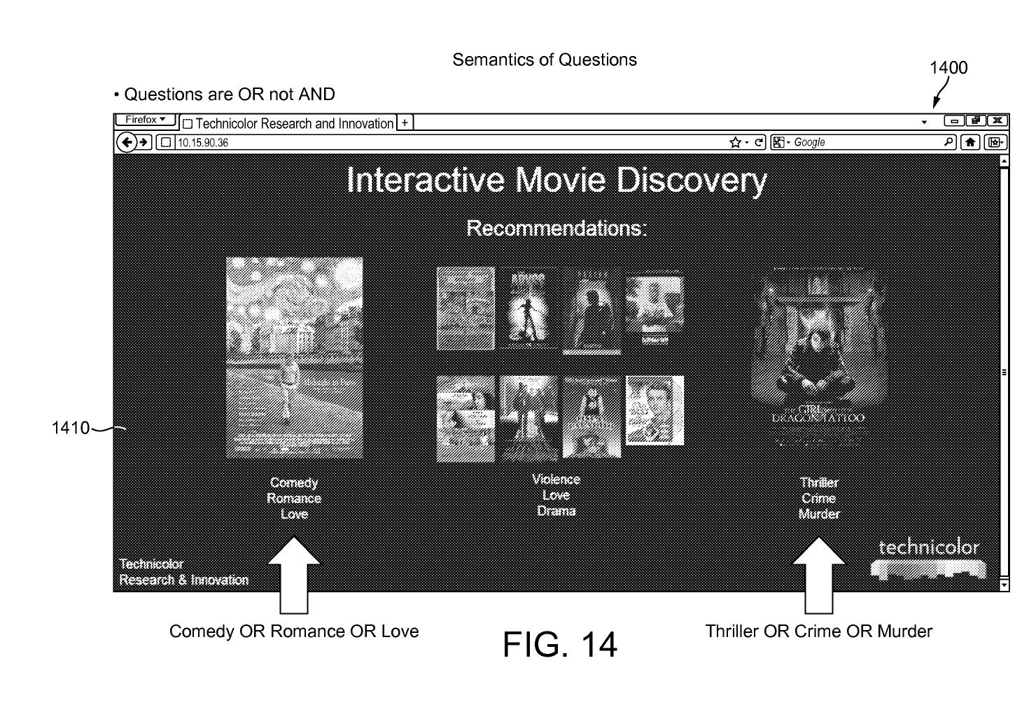

Referring now to FIG. 14, it is noted that when the user is presented with a user interface 1400 having a display area 1410 displaying a collection of media assets including a leftmost media asset (“Midnight in Paris”), a rightmost media asset (“The Girl With The Dragon Tattoo”), and a number of recommended media assets, the categories shown as being relevant to the media assets preferably result in “OR” questions, not “AND” questions, being presented to the user. For example, by selecting the leftmost media asset (“Midnight in Paris”), the user is indicating that the user would like to be presented with recommendations related to Comedy, Romance or Love categories. Similarly, by selecting the rightmost media asset (“The Girl With The Dragon Tattoo”), the user is indicating that the user would like to be presented with recommendations related to Thriller, Crime or Murder categories.

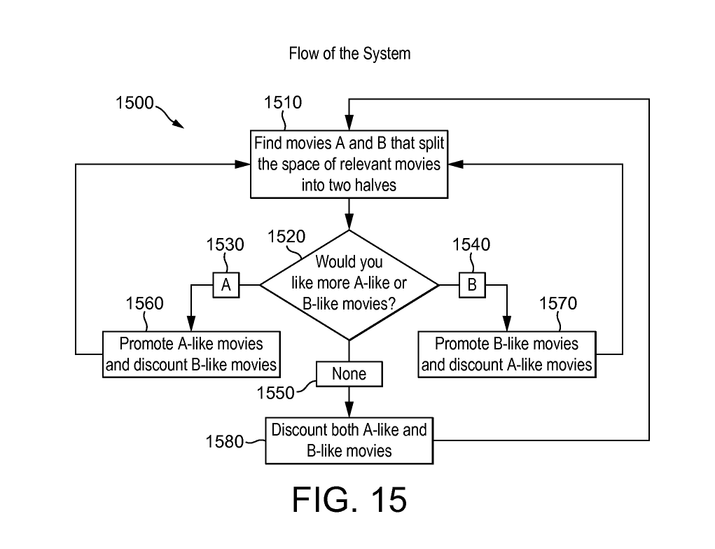

Referring now to FIG. 15, a process 1500 for providing recommendations, in accordance with the present disclosure, is shown. Initially, at step 1510, a recommendation engine (e.g., recommendation engine 118 or a local recommendation engine or processor integrated within receiving device 108, display device 114, or touch screen devices 116, 300), pursuant to the exemplary media asset discovery algorithm discussed in further detail below, finds or identifies two media assets (e.g., movie A and Movie B) in a media asset library or database (e.g., local movie database, remote movie database, combination of movie database, etc.) that split the space of available media assets into two halves. Next, at step 1520, the two media assets are presented to the user in a user interface as shown in FIGS. 5-14 (e.g., movie A in a leftmost media asset location and movie B in a rightmost media asset location). Afterwards, the recommendation engine or processor determines if the user, at step 1530, has selected the first media asset (e.g., Movie A), or, at step 1540, if the user has selected the second media asset (e.g., Movie B), or, at step 1550, if the user selects neither the first or second media asset and requests for a new set of recommended media assets. If the first media asset (e.g., Movie A), at step 1530, is selected the process, at step 1560 and in accordance with the exemplary media asset discovery algorithm discussed in further detail below, promotes media assets having metadata, characteristics, criteria or categories similar to the first media asset (e.g., Movie A) and discounts media assets having metadata, characteristics, criteria or categories similar to the second media asset (e.g., Movie B) returns to step 1510 to provide a new set of recommended movies to the user. If the second media asset (e.g., Movie B), at step 1540, is selected the process, at step 1570 and in accordance with the exemplary media asset discovery algorithm discussed in further detail below, promotes media assets having metadata, characteristics, criteria or categories similar to the second media asset (e.g., Movie B) and discounts media assets having metadata, characteristics, criteria or categories similar to the first media asset (e.g., Movie A) returns to step 1510 to provide a new set of recommended movies to the user. If neither the first media asset (e.g., Movie A) or the second media asset (e.g., Movie B) is selected, at step 1550, then the process, at step 1580 and in accordance with the exemplary media asset discovery algorithm discussed in further detail below, discounts both media assets having metadata, characteristics, criteria or categories similar to the first media asset (e.g., Movie A) and the second media asset (e.g., Movie B) and returns to step 1510 to provide a new set of recommended movies to the user. It should be noted that process 1500 may continue to loop, repeat or reiterate until the user is presented with a media asset that the user selects for consumption (e.g., including, but not limited to, purchasing, renting, downloading, storing, viewing or the like).

An exemplary media discovery algorithm wherein the media assets are selected to be movies, in accordance with the present disclosure, is as follows:

### Inputs:

n movies
K movie tags
n×1 vector w of movie relevance weights
   // w(i) is the weight of movie i
n×K matrix M of movie tags
   // M(i, k)=1 if the tag k is present in the movie i

### Algorithm:

initialize all weights w(i) to 1
while (solution is not among the top movies)
   solve:

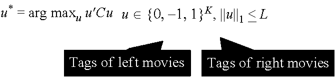

where u is a sparse vector of questions (at most L non-zero elements) and C is the covariance matrix of movie tags weighted by the relevance weights w
the tags of the left (right) movie correspond to the negative (positive) components of u*
if the person chooses the right movie
   update w(i) for all i as w(i)=w(i) 0.5̂(−M(i, :) u)
   // promote right-like movies and discount left-like movies else if the person chooses the left movie
   update w(i) for all i as w(i)=w(i) 0.5̂(M(i, :) u)
   // promote left-like movies and discount right-like movies else if the person asks for another question
   update w(i) for all i as w(i)=w(i) 0.5̂(M(i, :) abs(u))
   // discount both left-like and right-like movies

As should be appreciated the system, process and algorithm of the present disclosure have the following benefits:
Questions (e.g., rightmost and leftmost media assets) are found and presented to a user in a manner that leads to the user's desired media asset in a minimum number of steps
The questions are represented by movie tags (e.g., rightmost and leftmost media assets)

Potential requirements for good questions (e.g., offering of leftmost and rightmost media assets for selection), include but are not necessarily limited to, the following:
Meaningful: There exists a media asset that contains a given set of tags
Discriminative: the questions are easy to answer (e.g., simply selecting a leftmost or rightmost media asset)
Fast convergence: The space of relevant media assets is split in two halves after each question is answered (e.g., after each leftmost or rightmost media asset is selected).

Another aspect of the present disclosure involves providing on a touch screen of a second screen device 116, 300 a preference selection interface for user data entry in response to prompts illustrating content options. As discussed above, the prompts may be in the form of questions seeking user input regarding their preferences. For example, a user might be presented with a question such as “would you prefer to watch an action movie or a romance?” Then the interface would enable the user to select one of the choices. As shown above (e.g., FIGS. 5-14), such content-preference questions may be presented in the form of a display illustrating two alternative content choices associated with different genres or themes. The interface enables the user to select which of the illustrated choices the user prefers. In accordance with an aspect of the disclosure, the selection interface may comprise two areas of the touch screen of the second screen device wherein each area corresponds to one of the content choices (e.g., leftmost and rightmost media asset locations). For example, each area may be an illustration of content recognizable by a user. The user touching one of the areas indicates the user prefers the corresponding content. In addition, the areas of the touch screen may be located for ease of use during a typical mode of holding the device such as one hand on each of two opposite edges of the device. For example, the areas of the touch screen may be suitably positioned to enable contact by two of the user's fingers, one from each hand, or the user's thumbs when the user's hands are positioned on opposite edges of the second screen device.

Another aspect of the present disclosure involves using one or more of the plethora of sensors beyond the usual touch screen interface that may be included in a typical companion device such as a tablet. For example, use of inertial sensors such as accelerometer and/or gyroscopic sensors. It is possible to exploit these devices and the sensors for providing a more intuitive and interactive content discovery experience for users. For example, another aspect of the disclosure involves determining user preference data as a function of changes in spatial orientation of a second screen device 116, 300 in response to prompts illustrating content options. As another example, a user may tilt the second screen device 116, 300 in one direction such as toward the side of the display showing one of the content choices to indicate the user prefers the content displayed on that side and tilt the device in the opposite direction to indicate a preference for the other choice. The tilt angle may be used to indicate the user's intensity of like or dislike for a particular content choice, e.g., more tilt indicates a greater preference for the corresponding content and/or a greater dislike for the alternative content.

Another aspect of the present disclosure involves determining user preferences in response to a rate of change of spatial orientation of the second screen device 116, 300 in response to prompts illustrating content options. For example, a user tilting the second screen device 116, 300 in one direction at a relatively rapid rate of tilt may indicate the user has a greater degree of preference or like for the content associated with that direction of tilt. A slower rate of tilt may indicate only some or minimal preference or like for the content corresponding to the direction of tilt. In addition, other orientation changes such as shaking or rapid change of tilt may indicate specific user preference conditions. For example, shaking in one direction or tilting back and forth in one direction such as left-right-left (e.g., wagging shown in FIG. 4) may indicate no preference or neither is preferred. Indication of lack of preference may result in the system providing two new content choices (e.g., as discussed in FIG. 15). Shaking or alternating tilt in a different direction such as front to back might indicate a request to reset or restart the preference process.

Another aspect of the present disclosure involves providing an interface combining two or more of the previously mentioned aspects of the disclosure.

These and other aspects of the present disclosure may be better understood in the context of two exemplary embodiments described below. In these exemplary embodiments, the touch screen and/or sensors such as accelerometer and/or gyroscopic sensors included in a second-screen or companion device 116, 300 are utilized in order to enable users to intelligently discover content. For the purposes of explaining the exemplary embodiment, the user is considered to be operating mostly in a “lean-back mode”. That is, the user does not have access to lean-forward interfaces such as a computer, keyboard and mouse.

The exemplary embodiment comprises the following components:
1. Backend server (e.g., content source 102, backend server 118 and/or usage database 120)—This component has indexed all the movie and other content information such as metadata and implements the algorithms (e.g., process 1500 of FIG. 15 and associated algorithm) for presenting the user with intelligent prompts for determining user preferences such as questions in the form of movie choice A or B. Furthermore, the system learns from every interaction. That is, a user's response to one prompt or question indicates a particular piece of preference information that is used to refine and adapt subsequent prompts or questions.
2. Frontend user interface (UI) (e.g., UIs 500-1500)—This component may be implemented as software designed to run on consumer devices 116, 300 such as tablets and mobile phones. The UI may comprise one or more of the aspects mentioned above and described further below in the context of two exemplary embodiments.
3.

In one exemplary embodiment, the UI of the frontend may enable a user to input data or indicate content preferences by using the touch screen of the second-screen device 116, 300. For example, as described above, a selection interface may comprise two areas (e.g., rightmost and leftmost media asset locations) of the touch screen of the second screen device 116, 300 wherein each area corresponds to a particular content choice. For example, each area may be an illustration of content in a form recognizable by a user. The user touching one of the areas indicates the user prefers the corresponding content. In addition, the areas of the touch screen may be located for ease of use during a typical mode of holding the device such as one hand on each of two opposite edges of the device. For example, the areas of the touch screen may be suitably positioned to enable contact by two of the user's fingers, one from each hand, or the user's thumbs when the user's hands are positioned on opposite edges of the second screen device.

In another exemplary embodiment of the frontend UI utilizes one or more built-in sensors of the second screen device such as one or more accelerometers. In accordance with principles of the disclosure, an embodiment comprises three accelerometer sensors, one for each of the axes (X-axis, Y-axis, Z-axis). The Z-axis is perpendicular to the surface of the screen of the companion device, while the other two axes are along the edges of the tablet device. These sensors can be sampled at a specified frequency as dictated by the application. In the present exemplary system, the accelerometer is sampled every 100 milliseconds. The accelerometer output is processed to detect pre-defined gestures, comprising:

1. Shake gesture

2. Tilt left gesture

3. Tilt right gesture

On detecting a gesture, the system takes appropriate action by calling suitable functions on the backend component via a remote procedure call (RPC) as is known in the art. In the current exemplary embodiment, the RPC mechanism uses standard JavaScript Object Notation (JSON) encoded requests to the server via HTTP. The RPC call is made with encoded information about the gesture that was detected on the tablet device 116, 300.

The exemplary embodiment implements a threshold capability for detecting if the device 116, 300 was shaken. For this, at each sample interval, the current acceleration value from the sensor is compared to the value that was sampled in the previous sample interval. In order to avoid detecting spurious events as detection, it is important to set the threshold correctly. Using an exemplary threshold value of 12, this is the difference in acceleration over the 100 ms interval. This threshold produces results that are accurate while reducing false positives. Other threshold values may be appropriate depending on factors such as the environment (e.g., amount of background vibrational noise). Variable or adaptive threshold capability that modifies or adapts the threshold in response to environmental conditions may also be implemented. Another consideration is that the present exemplary embodiment only uses the accelerometer along the Z-axis thereby preventing detection of the tilt gesture as a shake gesture. One example of using the shake gesture may be returning to the initial screens 500, 900 and/or to step 1510 is response to a shake gesture.

The exemplary embodiment further comprises a tilt detection capability. Tilt is calculated as a proportion of acceleration on the Y-axis to the total acceleration. Assuming that aₓ, a_{y} and a_{z} are acceleration in m/s² the total acceleration is:

$$total Accel = \sqrt{{a}_{x}^{2} + {a}_{y}^{2} + {a}_{z}^{2}}$$

$$tilt Y = {sin}^{- 1} ( \frac{{a}_{y}}{total Accel} )$$

where:

tiltY—the tilt in radians.

totalAccel—acceleration in m/s²

The tilt determined as described is substantially the tilt along the bottom edge of the screen, assuming the device 116, 300 is in landscape mode. If the UI is being rendered in portrait mode, the system then determines the acceleration along the X-axis. If the tilt value produced by a gesture is negative, the gesture is determined to be a tilt-left gesture. Otherwise, the gesture is determined to be a tilt-right gesture.

As in the case of shake detection, the tilt detection capability of the exemplary embodiment includes a threshold to make sure that spurious events are not detected as tilt. In the described system, an exemplary threshold of 0.7 (˜pi/4 radians) is used. The exemplary threshold enables the user to quickly and accurately make a gesture while effectively avoiding false positives. Also as in the case of the threshold for shake detection, other threshold values may be appropriate depending on factors such as the system, environment, etc., and variable or adaptive threshold capability may also be included. One exemplary use of the tilt gesture may be using detected tilt gestures to identify or determine selection of media assets as described in FIGS. 5-14 and discussed in steps 1530 and 1540 of FIG. 15.

Although embodiments which incorporate the teachings of the present disclosure have been shown and described in detail herein, those skilled in the art can readily devise many other varied embodiments that still incorporate these teachings. Having described preferred embodiments of a system, method and user interface for media asset recommendations (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the disclosure.

1. A method for providing media recommendations, the method comprising:
enabling a user to select a first media object or a second media object from a plurality of accessible media objects, the first media object having a first set of characteristics and the second media object having a second set of characteristics;
determining if a user selects the first media object, selects the second media object, or requests access to two different media objects;
adjusting weight values associated with the plurality of media objects based on the user's selection; and
recommending media objects to the user based on the adjusted weight values.

2. The method of claim 1, wherein the step of adjusting further comprises:
increasing the weight values of media objects in the plurality of accessible media objects that have characteristics similar to the first media object and decreasing the weight values of media objects in the plurality of accessible media objects that have characteristics similar to the second media object if it is determined that the user selected the first media object.

3. The method of claim 1, wherein the step of adjusting further comprises:
increasing the weight values of media objects in the plurality of accessible media objects that have characteristics similar to the second media object and decreasing the weight values of media objects in the plurality of accessible media objects that have characteristics similar to the first media object if it is determined that the user selected the second media object.

4. The method of claim 1, wherein the step of adjusting further comprises:
decreasing the weight values of media objects in the plurality of accessible media objects that have characteristics similar to the first and second media objects if it is determined that the user requested access to two different media objects.

5. The method of claim 1, wherein the step of determining further comprises:
detecting if the user has made a gesture with a control device.

6. The method of claim 5, wherein the gesture is at least one of a tilt or shake.

7. The method of claim 1, wherein the media objects are at least one of movies, albums, and books.

8. A system for providing media recommendations, the system comprising:
means for enabling a user to select a first media object or a second media object from a plurality of accessible media objects, the first media object having a first set of characteristics and the second media object having a second set of characteristics;
means for determining if a user selects the first media object, selects the second media object, or requests access to two different media objects;
means for adjusting weight values associated with the plurality of media objects based on the user's selection; and
means for recommending media objects to the user based on the adjusted weight values.

9. The system of claim 8, wherein the means for adjusting further comprises:
means for increasing the weight values of media objects in the plurality of accessible media objects that have characteristics similar to the first media object and decreasing the weight values of media objects in the plurality of accessible media objects that have characteristics similar to the second media object if it is determined that the user selected the first media object.

10. The system of claim 8, wherein the means for adjusting further comprises:
means for increasing the weight values of media objects in the plurality of accessible media objects that have characteristics similar to the second media object and decreasing the weight values of media objects in the plurality of accessible media objects that have characteristics similar to the first media object if it is determined that the user selected the second media object.

11. The system of claim 8, wherein the means for adjusting further comprises:
means for decreasing the weight values of media objects in the plurality of accessible media objects that have characteristics similar to the first and second media objects if it is determined that the user requested access to two different media objects.

12. The system of claim 8, wherein the means for determining further comprises:
means detecting if the user has made a gesture with a control device.

13. The system of claim 12, wherein the gesture is at least one of a tilt or shake.

14. The system of claim 8, wherein the media objects are at least one of movies, albums, and books.
